(19) United States
(12) Patent Application Publication
(10) Pub. No.: US 2015/0144233 A1
(43) Pub. Date: May 28, 2015

(54) HYBRID MOLD STEEL AND MANUFACTURING METHOD THEREOF

(71) Applicant: DOOSAN HEAVY INDUSTRIES & CONSTRUCTION CO., LTD., Changwon-Si (KR)

(72) Inventors: Young Chul PARK, Pohang-si (KR); Soo Mok LEE, Changwon-si (KR); Myeong Su JANG, Busan (KR); Jei Yeong JEON, Changwon-si (KR)

(73) Assignee: DOOSAN HEAVY INDUSTRIES & CONSTRUCTION CO., LTD., Changwon-Si (KR)

(21) Appl. No.: 14/554,373

(22) Filed: Nov. 26, 2014

(30) Foreign Application Priority Data
Nov. 27, 2013 (KR) 10-2013-0145755

(51) Int. Cl. B29C 45/26; C21D 9/00; C21D 1/18; C21D 6/00; C22C 38/58; C22C 38/54; C22C 38/46; C22C 38/44; C22C 38/42; C22C 38/04; C22C 38/02; B21B 1/02; B21B 3/02; B21J 5/06; C21D 8/00

(52) U.S. Cl. CPC B29C 45/26; C21D 8/005; C21D 9/0068; C21D 1/18; C21D 6/004; C21D 6/005; C21D 6/008; C22C 38/58; C22C 38/54; C22C 38/46; C22C 38/44; C22C 38/42; C22C 38/04; C22C 38/02; B21B 1/024; B21B 3/02; B21J 5/06; C21D 2211/001
USPC 148/645; 148/649; 420/91; 420/106; 420/109; 420/108; 72/200; 72/352

(57) ABSTRACT

Provided is a mold steel for plastic injection that is excellent in fatigue strength and tensile strength and available for long term use, where the mold steel includes: 0.15 to 0.40 wt. % of carbon (C), 0.15 to 0.50 wt. % of silicon (Si), 0.70 to 1.50 wt. % of manganese (Mn), 0.50 to 1.20 wt. % of nickel (Ni), 1.50 to 2.50 wt. % of chrome (Cr), 0.25 to 0.70 wt. % of molybdenum (Mo), 0.20 wt. % or less of vanadium (V), 0.010 wt. % or less of boron (B), and a trace of iron (Fe) and a plurality of impurities.

### CROSS-REFERENCE TO RELATED APPLICATION

This application claims priority from Korean Patent Application No. 10-2013-0145755, filed on Nov. 27, 2013 the disclosure of which is incorporated herein by reference in its entirety.

### BACKGROUND

1. Field

Apparatuses and methods consistent with exemplary embodiments relate to a mold steel and its manufacturing method and, more particularly to, a mold steel that is for plastic injection and available in long-term use because of fatigue strength excellence and tensile strength excellence, and manufacturing method thereof.

2. Description of the Related Art

In the related art, molds are used to manufacture a large number of products of the same shape and plastic products are representative products manufactured using the molds. Plastic products are produced primarily by the injection molding method that involves injecting a melt plastic resin into a mold, imposing a pressure and then cooling down the mold to complete a product. The plastic products are increasingly in need of satisfying more requirements with the development of the industries such as of automobile products, home appliances, precision instrument parts, household goods, etc. and now widely used.

The mold steel that is the most fundamental ingredient of the mold essential in the manufacture of plastic products is required to have various characteristics according to the use purpose of the mold. The essential characteristics of the mold steel are uniform cross-sectional hardness, good cutting processability, good weldability, etching processability, minor-finished surface property, fatigue strength, and so forth.

Korean Laid-Open Patent Publication No. 10-2012-0072499 (published on Jul. 4, 2012) and Korean Registration Patent Publication No. 10-1051241 (filed on Jul. 15, 2011) disclose molds which satisfy such requirements.

Korean Laid-Open Patent Publication No. 10-2012-0072499 relates to a precipitation hardening mold steel with high hardness and high toughness and a manufacturing method thereof, where the mold steel has a composition including 0.05 to 0.13 wt. % of Carbon (C), 0.2 to 1.2 wt. % of Silicon (Si), 1.3 to 1.7 wt. % of Manganese (Mn), 0.2 to 1.0 wt. % of Chromium (Cr), 0.2 to 1.0 wt. % of Molybdenum (Mo), 2.5 to 3.5 wt. % of Nickel (Ni), 0.7 to 1.5 wt. % of Copper (Cu), 0.7 to 1.5 wt. % of Aluminum (Al), 0.01 to 0.1 wt. % of Niobium (Nb), less than 0.006 wt. % of Sulfur (S), and Iron (Fe) and other inevitable impurities for the remainder and consists of a bainite-martensite composite structure and the manufacturing method includes hot-processing a steel composed of the above-mentioned components, heating the steel at a temperature higher than the austenite transformation finish temperature Ac3 during the reheating step, maintaining the temperature for a predetermined period of time, cooling down to the room temperature at a cooling rate of 0.5° C./min to 20° C./sec and then performing an aging process at a temperature of 530 to 560° C.

Korean Registration Patent Publication No. 10-1051241 relates to a method for manufacturing a mold steel excellent in hardness uniformity and mechanical strengths that includes (a) founding an ingot including 0.25 to 0.35 wt. % of carbon (C), 0.20 to 0.35 wt. % of silicon (Si), 0.80 to 1.00 wt. % of manganese (Mn), less than 0.015 wt. 5 of phosphor (P), 0.005 to 0.010 wt. % of sulfur (S), 1.00 to 1.21 wt. % of chrome (Cr), 0.20 to 0.40 wt. % of nickel (Ni), 0.20 to 0.40 wt. % of molybdenum (Mo), 0.03 to 0.05 wt. % of vanadium (V), 0.002 to 0.004 wt. % of boron (B), 0.020 to 0.035 wt. % of titanium (Ti), less than 0.01 wt. % of nitrogen (N) and Fe and other inevitable impurities for the remainder, (b) upsetting the ingot by heating in a furnace, and (c) reheating the upset ingot and forming a die by open die forging.

According to the above-identified references, however, the mold steel has been developed for the main purpose of acquiring high hardness and high toughness, or obtaining uniform hardness of a large-sized mold steel, or improving processability. In recent years, a demand for plastics has steadily increased in different fields, such as of automobile, electronics and home appliances, household items, etc. and the plastic resins have been diversified. Further, with an increase in the use of hard resins and the quantity of injected resins, the use of the mold steel of related art adversely results in a need of producing additional molds due to poor fatigue strength of the conventional mold steel.

### SUMMARY

For solving the problem aforementioned, one or more exemplary embodiments provide a mold steel excellent in fatigue and tensile strength as acquired by optimizing the composition of the alloy including carbon, silicon, manganese, chrome, molybdenum, nickel, vanadium, etc. and its manufacturing method.

One or more exemplary embodiments also provide a mold steel capable of enhancing the productivity of plastics and its manufacturing method.

According to an aspect of an exemplary embodiment, there is provided a mold steel including 0.15 to 0.40 wt. % of carbon (C), 0.15 to 0.50 wt. % of silicon (Si), 0.70 to 1.50 wt. % of manganese (Mn), 0.50 to 1.20 wt. % of nickel (Ni), 1.50 to 2.50 wt. % of chrome (Cr), 0.25 to 0.70 wt. % of molybdenum (Mo), 0.20 wt. % or less of vanadium (V), 0.010 wt. % or less of boron (B), and a trace of iron (Fe) and a plurality of impurities.

The mold steel may further include 0.08 wt. % or less of zirconium (Zr) and 1.0 wt. % or less of copper (Cu).

The plurality of impurities may include at least one of the phosphor (P), sulfur (S), aluminum (Al) and nitrogen (N).

The remainder of the mold steel may include iron (Fe).

According to an aspect of an exemplary embodiment, there is provided a method for manufacturing a mold steel, include: preparing a steel ingot comprising carbon (C), 0.15 to 0.50 wt. % of silicon (Si), 0.70 to 1.50 wt. % of manganese (Mn), 0.50 to 1.20 wt. % of nickel (Ni), 1.50 to 2.50 wt. % of chrome (Cr), 0.25 to 0.70 wt. % of molybdenum (Mo), 0.20 wt. % or less of vanadium (V), 0.010 wt. % or less of boron (B), and a trace of iron (Fe) and other impurities for the remainder; heating the prepared steel ingot; performing a forging or rolling process, or a forging process and a rolling process in a sequence to prepare a mold material from the heated steel ingot; preheating the prepared mold material; and quality-heating the pre-heated mold material.

The steel ingot further comprises 0.08 wt % of less of zirconium (Zr) and 1.0 wt. % of less of copper (Cu).

The method may further include performing an electro-slag remelting (ESR) process prior to the heating the steel ingot.

The heating the steel ingot may include heating at a temperature of 850 to 1,300° C.

The forging or rolling process or the forging process and the rolling process in the sequence may be performed at a temperature of 850 to 1,300° C.

The preheating the prepared mold material may include heating at a temperature of 800 to 950° C. to perform austenitization and recrystallization and then air-cooling to perform a normalizing process.

The preheating the prepared mold material may include heating at a temperature of 800 to 950° C. to perform austenitization and recrystallization and then furnace-cooling to perform an annealing process.

Therein the quality-heating the pre-heated mold material may include heating at 850 to 1,000° C. to perform transformation into austenite, quenching by any one cooling method selected from oil cooling, air cooling, or water cooling and then tempering at 400 to 650° C.

### EFFECTS OF CLAIMED INVENTION

As described above, the mold steel and its manufacturing method according to exemplary embodiments provide fatigue and tensile strength excellence to eliminate the need for additional manufacture of molds, thereby reducing the cost for additional manufacture of molds.

In addition, the mold steel and its manufacturing method according to exemplary embodiments facilitate the large-scaled injection-based production of plastics.

### BRIEF DESCRIPTION OF DRAWINGS

FIG. 1 is a flow chart for explaining a method for manufacturing a mold steel according to an exemplary embodiment.

FIG. 2 is a diagram showing an S—N curve obtained by the fatigue strength testing on an exemplary embodiment and the comparative examples of the related art.

FIG. 3 is a diagram showing the yield strength and the tensile strength of an exemplary embodiment and the comparative examples of the related art.

FIG. 4 is a diagram showing the shock absorbing energy, that is, the Charpy impact toughness, of the novel steel of an exemplary embodiment and the comparative examples of the related art.

FIG. 5 is a diagram showing the hardness as a function of the distance from the core of an exemplary embodiment and the comparative examples of the related art.

FIG. 6 is a diagram showing the cleanness of an exemplary embodiment and the comparative examples of the related art.

### DETAILED DESCRIPTION

Hereinafter, a detailed description will be given as to exemplary embodiments with reference to the accompanying drawings so as for the those skilled in the art to readily carry out the inventive concept. But, in the detailed description of the operational principles regarding the exemplary embodiments, the specific description as to the known functions or constructions is to be excluded when it is considered to unnecessarily depart from the inventive concept.

Hereinafter, the individual components of the steel according to the exemplary embodiment and the reasons for their limited use will be described.

The components of the steel of an exemplary embodiment includes carbon (C), silicon (Si), manganese (Mn), nickel (Ni), chrome (Cr), molybdenum (Mo), vanadium (V), boron (B), zirconium (Zr), copper (Cu), and a trace of iron (Fe) and other impurities, such as phosphor (P), sulfur (S), aluminum (Al), hydrogen (H), oxygen (O), nitrogen (N), etc.

The carbon (C) is an element used to enhance hardness, strength, hardenability, and abrasion resistance and preferably added in an amount of 0.15 to 0.40 wt. %. The content of the carbon being less than 0.15 wt. % lowers hardness and strength and reduces hardenability to acquire uniform cross-sectional hardness, while the content of the carbon being greater than 0.40 wt. % reduces cutting processability and weldability.

The silicon (Si) is an element used as a deoxidizing agent necessary in the steel making process for manufacturing a steel ingot and added in an amount of 0.15 to 0.50 wt. %. The content of the silicon less than 0.15 wt. % is not sufficient to carry out the deoxidization process and leads to the failure to make a clean steel ingot, while the content of the silicon greater than 0.50 wt. % undesirably brings about graphitization and embrittlement of cementite and reduces the forgeability.

The manganese (Mn) is an element used to enhance the hardenability and form a MnS compound. When the Mn is added in an amount of less than 0.70 wt. %, the hardenability is decreased, with the consequence of the failure to obtain uniform cross-sectional hardness and the sulfur combines with iron to form FeS rather than with manganese to form MnS, which FeS causes hot shortness burning and deteriorates the forgeability. In contrast, when the Mn is added in an amount of greater than 1.50 wt. %, an excess of coarse MnS is formed not only to deteriorate fatigue strength and toughness but also to adversely affect the mirror-finished surface property that is one of the required characteristics to the plastic injection mold. Therefore, the content of the manganese is preferably in the range of 0.70 to 1.50 wt. %.

The nickel (Ni) is an element used to enhance the stability at high temperature as well as the toughness and the hardenability and preferably added in an amount of 0.50 to 1.20 wt. %. The content of the nickel less than 0.50 wt. % reduces the effect of enhancing the toughness to prevent a deterioration of the toughness that is necessary according to the increase in the hardness and the strength, while the content of the nickel greater than 1.20 wt. % produces remaining austenite, causing the structure to be unstable and possibly deform when in use, reduces the cutting processability and leads to uneconomical effects.

The chrome (Cr) is an element used to enhance the hardenability and form a composite carbide to enhance hardness, strength, tempering-softening resistance, and abrasion resistance. When the chrome is added in an amount of less than 1.50 wt. %, the effect of enhancing the hardenability is deteriorated to fail in acquiring uniform cross-sectional hardness and the formation of a composite carbide with molybdenum, vanadium, etc. is decreased to reduce the tempering-softening resistance and the effect of enhancing the strength and the oxidation resistance. When the chrome is added in an amount of greater than 2.50 wt. %, the abrasion resistance is abruptly increased, making it difficult to etch out a pattern in making a mold, with the consequence of poor etched pattern processability.

The molybdenum (Mo) is an element that enhances the hardness and the strength, causes a secondary hardening effect at high temperature during the tempering process to enhance the high-temperature strength and combines with phosphor present in the grain boundary to prevent tempering embrittlement caused by phosphor during the tempering heat treatment. When the molybdenum is added in an amount of less than 0.25 wt. %, the effect of suppressing the tempering embrittlement is deteriorated and the secondary hardening effect is reduced to decrease the hardness and the strength at high temperature. When the molybdenum is added in an amount of greater than 0.70 wt. %, it not only decreases the effect of molybdenum but also has an uneconomical effect.

The vanadium (V) is an element that not only forms a carbide to increase the hardness and enhance the tempering resistance but also makes the crystal grains refined to enhance the toughness. When the vanadium is added in an amount of greater than 0.20 wt. %, the refining effect of crystal grains appears prominently to deteriorate the hardenability, making it impossible to acquire uniform cross-sectional hardness and bring about an uneconomical effect. Therefore, the vanadium is preferably added in an amount of 0.20 wt. % or less.

The boron (B) is an element capable of suppressing the nucleation of ferrite to maximize the effect of enhancing the hardenability. When the boron is added in an amount of greater than 0.010 wt. %, boron precipitates, such as BN and Fe₂₃(CB)₆, are formed in the crystal grain boundary, causing embrittlement during the hot forging process and deteriorating the mechanical properties such as impact toughness. It is therefore desirable to use the boron in an amount of 0.010 wt. % or less in order to obtain a synergy effect of enhancing the hardenability in combination with the elements for enhancing the hardenability as contained in the steel, such as manganese, chrome, nickel, etc.

The zirconium (Zr) is an element that has an effect to spheriodize a non-metallic inclusion and improve the processability. The content of the zirconium greater than 0.08 wt. % reinforces the base structure to deteriorate the mechanic processability. It is therefore desirable to use the zirconium in an amount of 0.08 wt. % or less.

The copper (Cu) is an element contained in the scrap iron. The content of the copper greater than 1.0 wt. % can cause a surface burst during the hot forging process. It is therefore desirable to use the copper in an amount of 1.0 wt. % or less.

The phosphor (P), sulfur (S), aluminum (Al) and nitrogen (N) are impure elements.

The remainder other than the above-mentioned components of the steel substantially consists of iron (Fe).

The expression “the remainder substantially consists of iron (Fe)” means that even containing other trace elements including inevitable impurities is included within the scope of the inventive concept as long as it does not inhibit the functional effects of the inventive concept.

Hereinafter, a description will be given as to a method for manufacturing a mold steel using the components of the steel as mentioned above.

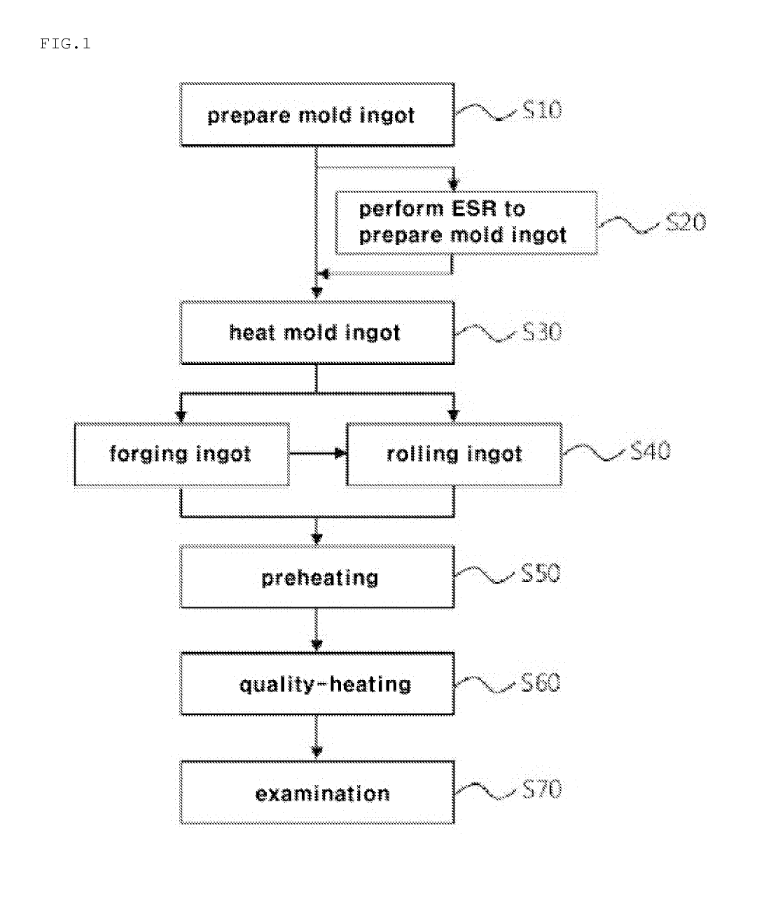

FIG. 1 is a flow chart for explaining a method for manufacturing a mold steel according to an exemplary embodiment.

As illustrated in FIG. 1, a steel ingot is manufactured, in step S10.

A metal is melted using an artificial heat source, such as, for example, one of an electric furnace, a vacuum induction furnace, or an airflow induction furnace. Then, the gas, such as oxygen, hydrogen, nitrogen, etc., generated during the steel making process is effectively eliminated to produce a steel ingot.

The steel ingot is comprised of carbon (C), silicon (Si), manganese (Mn), nickel (Ni), chrome (Cr), molybdenum (Mo), vanadium (V), boron (B), and a trace of iron (Fe) and other impurities for the remainder; preferably, 0.15 to 0.40 wt. % of carbon (C), 0.15 to 0.50 wt. % of silicon (Si), 0.70 to 1.50 wt. % of manganese (Mn), 0.50 to 1.20 wt. % of nickel (Ni), 1.50 to 2.50 wt. % of chrome (Cr), 0.25 to 0.70 wt. % of molybdenum (Mo), 0.20 wt. % or less of vanadium (V), 0.010 wt. % or less of boron (B), and a trace of iron (Fe) and other impurities for the remainder.

Preferably, the steel ingot further includes 0.08 wt. % or less of zirconium (Zr) and 1.0 wt. % or less of copper (Cu) in order not to reduce the cutting processability.

Subsequently, the iron ingot manufactured in the step S10 is used to selectively prepare an electro-slag re-melting (ESR) steel ingot, in step S20.

When the steel ingot prepared in the step S10 is applied to a mold required to have a high mirror-finished toughness, it is desirable to further selectively perform an electro-slag re-melting (ESR) process in order to minimize the filled quantity and enhance the minor-finished toughness.

The steel ingot is then heated, in step S30.

The steel ingot prepared in the steps S10 and S20 is heated up to a temperature of 850° C. to 1,300° C. for the preparation of the forging or rolling process that is a process for providing a desired shape. When the steel ingot is heated at a temperature below 850° C., the forging or rolling process is hard to carry out due to such a low temperature. Contrarily, when the steel ingot is overheated up to a temperature above 1,300° C., the overheat can cause embrittlement with overheating. It is therefore desirable to heat the steel ingot in the above-specified temperature range.

Subsequently, the heated steel ingot is subjected to the forging or rolling process, or to the forging process and the rolling process in sequence to produce a mold material, in step S40.

The steel ingot heated in the step S30 is subjected to the forging or rolling process, or to the forging process and the rolling process in sequence at a temperature of 850° C. to 1,300° C. to destroy the cast structure of the steel ingot, and the inner pores of the steel ingot caused during the hardening process are compressed and eliminated to enhance the internal quality and make the shape of the mold material. When the temperature of the forging or rolling process is below 850° C., it is difficult to achieve transformation during the forging or rolling process, thereby giving cracks. When the temperature of the forging or rolling process is above 1,300° C., high-temperature embrittlement takes place due to overheat to form cracks. It is therefore desirable to perform the forging or rolling process at a temperature of 850° C. to 1,300° C.

Next, the mold material is pre-heated, in step S50.

The mold material made in the step S40 is rolled out after the forging or rolling process, or a sequence of the forging and rolling processes, so the microstructure and the crystal grains are coarse and not uniform. Thus, the pre-heating process is carried out prior to the quality heating process to recrystallize the non-uniform crystal grains and the microstructure formed in the previous process, and the crystal grains and the microstructure are refined to achieve uniformity, thereby acquiring good required properties in the subsequent quality heat treatment process. The pre-heating method is employed to carry out a normalizing process or an annealing process. The mold material is heated up to a temperature of 800° C. to 950° C. to achieve austenitization and recrystallization and then air-cooled down for the normalizing process or furnace-cooled down for the annealing process, thereby obtaining a fine and uniform perlite structure. It is therefore desirable to perform a normalizing or annealing process by heating at a temperature of 800° C. to 950° C. When the normalizing or annealing temperature is lower than 800° C., recrystallization occurs in a non-uniform way to get non-uniform crystal grains to make the microstructure not uniform after the preheating process. When the normalizing or annealing temperature is higher than 950° C., the crystal grains become coarse, making it difficult to acquire good properties in the quality heating process. It is therefore preferable to perform the pre-heating process in the above-specified temperature range.

Subsequently, the preheated mold material is subjected to a quality heating process, in step S60.

The mold material preheated in the step S50 is transformed into austenite by heating up to a temperature higher than the Ac3 transformation temperature, preferably in the range of 850° C. to 1,000° C., more preferably 930° C. and then quenched by using any one cooling method selected from oil cooling, air cooling, or water cooling. When the temperature is lower than 850° C., it makes the carbide difficult to reuse, reduces the hardenability, deteriorates the tensile strength, and increases the hardness deviation. When the temperature is higher than 1,000° C., the crystal grains become coarse to deteriorate the impact toughness and the tensile strength. It is therefore desirable to make a martensite structure or a bainite structure uniform and fine by heating the mold material up to a temperature of 850° C. to 1,000° C. and then cooling down for quenching.

In order to improve the embrittlement of the steel caused by the quenching process, eliminate the residual stress and acquire a defined strength and impact toughness, the mold material is tempered at a temperature lower than the Ar1 transformation temperature, preferably in the range of 400° C. to 650° C. When the tempering temperature is lower than 400° C., the residual stress remains due to such a low temperature and the effect of improving the toughness on the martensite having embrittlement is insignificant. In contrast, when the tempering temperature is above 650° C., a defined strength and hardness becomes difficult to acquire. It is therefore desirable to temper the mold material at a temperature of 400° C. to 650° C.

Subsequently, the heated mold material is examined, in step S70.

The mold material heated in the step S60 is examined to determine whether it has any unsound part, and if any, the unsound part is removed to release the mold material.

After completion of the examination process, the complete mold steel is obtained. The mold steel prepared by the above-described manufacturing method has excellence in terms of fatigue strength and tensile strength, making the mold available for a long-term use and thus ecofriendly, reduces the need for additional manufacture of the mold, thereby decreasing the production cost caused by the additional manufacture of the mold, and facilitates the large-scaled injection production of plastics.

### EXPERIMENTAL EXAMPLE 1

### Chemical Compositional Analysis on Mold Steel

A chemical compositional analysis is carried out on the mold steel of the exemplary embodiment as prepared by the manufacturing method of the exemplary embodiment (hereinafter, referred to as “exemplary embodiment steel”) and mold steels A, B and C for plastic injection as prepared by the manufacturing method of the related art. The mold steels A, B and C for plastic injection as prepared by the conventional manufacturing method are referred to as “comparative steels A, B and C”. The comparative steel A is disclosed in the prior art reference, KR 10-0346306, the comparative steel B is disclosed in the prior art reference, KR 10-0263426, and the comparative steel C is disclosed in the prior art reference, KR 10-0960088. The chemical components of the comparative steels A, B and C are chemical components of the products commercially available. The chemical components of the exemplary embodiment steel are chemical components of the product prepared in the scale commercially available according to the optimal alloy design not only to satisfy the various requirements to the mold steel but also to enhance the fatigue strength and using a 100-ton electric furnace and refinery and a 13,000-ton press and heating furnace.

Table 1 presents the chemical compositions of the exemplary embodiment steel and the comparative steels A, B and C.

As shown in Table 1, the exemplary embodiment steel has a higher content of silicon (Si), chrome (Cr), nickel (Ni), molybdenum (Mo), vanadium (V), and copper (Cu) than the conventional mold steels.

TABLE 1

| | Exemplary | Comparative | Comparative | Comparative |
|---|---|---|---|---|
| Div. | embodiment steel | Steel A | Steel B | Steel C |
| C (%) | 0.32 | 0.26 | 0.33 | 0.27 |
| Si (%) | 0.35 | 0.24 | 0.25 | 0.22 |
| Mn (%) | 0.95 | 0.97 | 0.88 | 0.81 |
| Ni (%) | 0.75 | 0.25 | 0.40 | 0.34 |
| Cr (%) | 2.13 | 1.87 | 1.15 | 1.28 |
| Mo (%) | 0.64 | 0.41 | 0.39 | 0.29 |
| V (%) | 0.10 | 0.05 | 0.04 | 0.04 |
| B (%) | 0.003 | 0.002 | 0.003 | 0.001 |
| Zr (%) | 0.015 | | | 0.008 |
| Cu (%) | 0.25 | | | 0.08 |

### EXPERIMENTAL EXAMPLE 2

### Fatigue Strength of Mold Steel

A rotation bending fatigue test is performed on the exemplary embodiment steel prepared by the manufacturing method of the exemplary embodiment and the comparative steels A, B and C prepared by the manufacturing method of the related art.

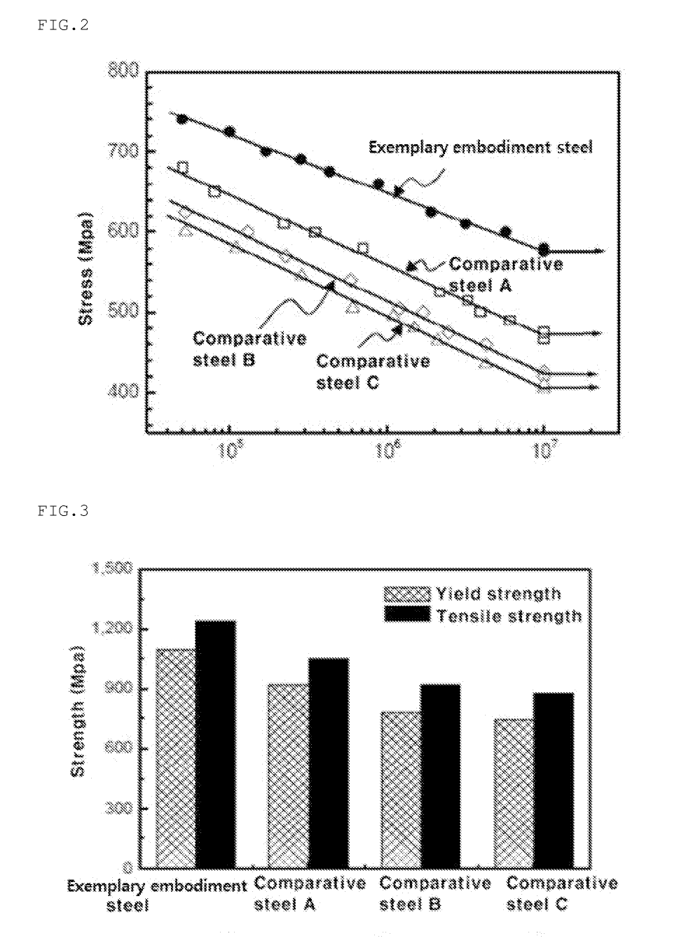

FIG. 2 is a diagram showing an S—N curve obtained by the fatigue strength testing on the exemplary embodiment steel and the comparative steels.

As illustrated in FIG. 2, the exemplary embodiment steel is far superior in the fatigue strength to the comparative steels A, B and C. Having a high fatigue strength means a greater longevity under the same stress in use. Thus it can be seen that the exemplary embodiment steel is available for a long-term use due to its high fatigue strength.

### EXPERIMENTAL EXAMPLE 3

### Yield Strength and Tensile Strength of Mold Steel

The exemplary embodiment steel prepared by the manufacturing method of the exemplary embodiment and the comparative steels A, B and C prepared by the manufacturing method of the related art are measured in regards to the yield strength and the tensile strength.

FIG. 3 is a diagram showing the yield strength and the tensile strength of the exemplary embodiment steel and the comparative steels.

As illustrated in FIG. 3, the exemplary embodiment steel has a yield strength of 1,101 Mpa and a tensile strength of 1,237 Mpa; the comparative steel A has a yield strength of 920 Mpa and a tensile strength of 1,050 Mpa; the comparative steel B has a yield strength of 780 Mpa and a tensile strength of 920 Mpa; and the comparative steel C has a yield strength of 740 Mpa and a tensile strength of 880 Mpa. It can be thus seen that the exemplary embodiment steel having considerably high yield strength and tensile strength is much superior in the mechanical strength to the comparative steels A, B and C.

### EXPERIMENTAL EXAMPLE 4

### Impact Toughness of Mold Steel

A Charpy impact toughness test is performed on the exemplary embodiment steel prepared by the manufacturing method of the exemplary embodiment and the comparative steels A, B and C prepared by the manufacturing method of the related art.

FIG. 4 is a diagram showing the shock absorbing energy, that is, the Charpy impact toughness, of the exemplary embodiment steel and the comparative steels.

As illustrated in FIG. 4, the exemplary embodiment steel has a shock absorbing energy of 6.1 Kgf·m; the comparative steel A has a shock absorbing energy of 5.9 Kgf·m; the comparative steel B has a shock absorbing energy of 4.6 Kgf·m; and the comparative steel C has a shock absorbing energy of 4.8 Kgf·m, which shows that the exemplary embodiment steel and the comparative steel A are excellent in the impact toughness. It can be thus seen that the deterioration of the toughness with the increase in the strength is prevented by adding nickel used to enhance the impact toughness and vanadium to make the size of the crystal grains microscopic.

### EXPERIMENTAL EXAMPLE 5

### Cross-Sectional Hardness of Mold Steel

A cross-sectional hardness test is performed on the exemplary embodiment steel prepared by the manufacturing method of the exemplary embodiment and the comparative steels A, B and C prepared by the manufacturing method of the related art.

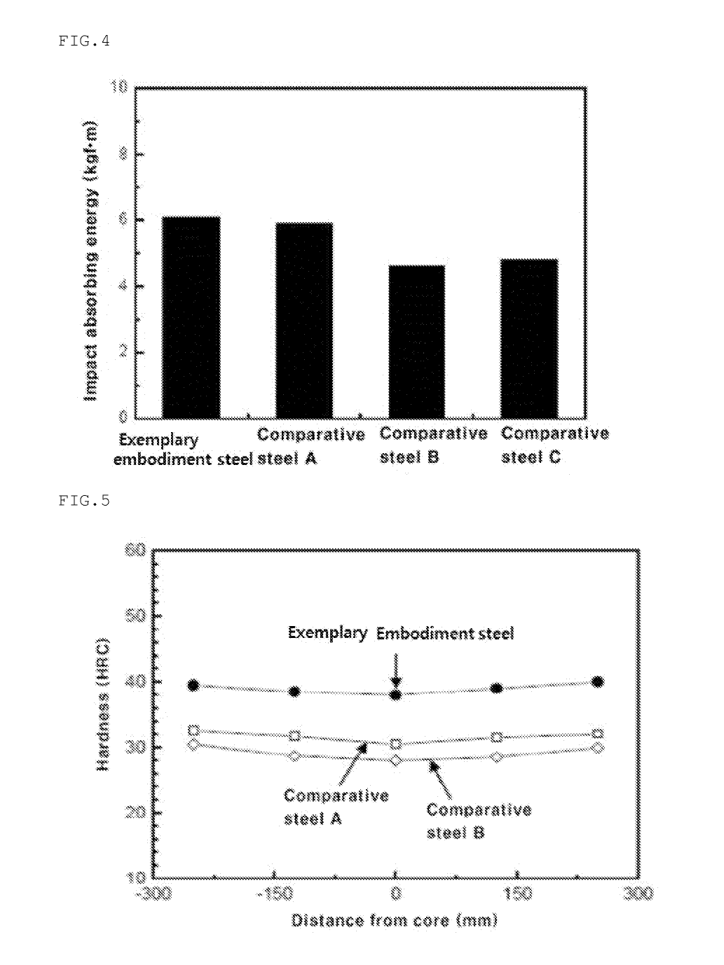

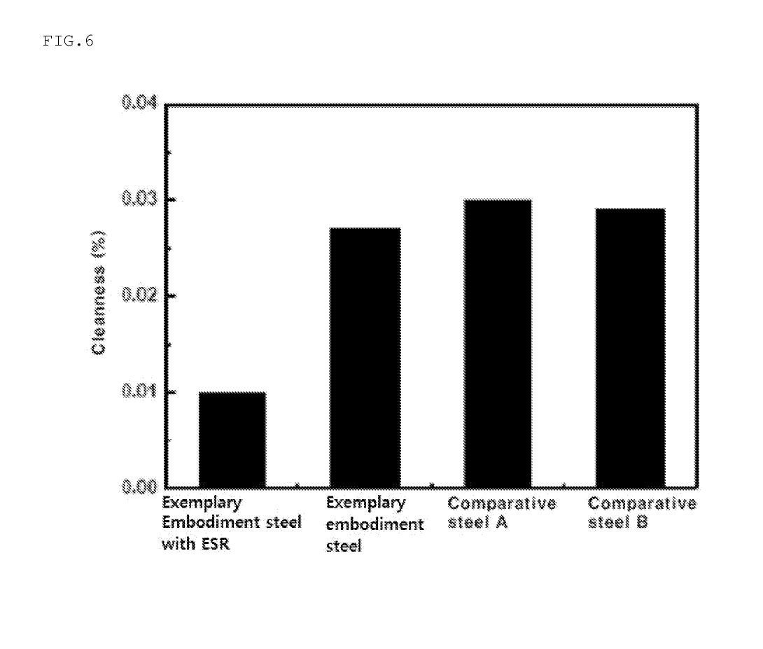

FIG. 5 is a diagram showing the hardness as a function of the distance from the core of the exemplary embodiment steel and the comparative steel.

As illustrated in FIG. 5, the exemplary embodiment steel has a hardness of HRC40; the comparative steel A has a hardness of HRC32; and the comparative steel B has a hardness of HRC30. This means that the hardness based on the distance from the core of each steel and that the cross-sectional hardness is uniform.

### EXPERIMENTAL EXAMPLE 6

### Cleanness of Mold Steel

A cleanness test is performed on the exemplary embodiment steel prepared by the manufacturing method of the exemplary embodiments with or without adding an ESR process and the comparative steels A and B prepared by the manufacturing method.

FIG. 6 is a diagram showing the cleanness.

As illustrated in FIG. 6, the exemplary embodiment steel manufactured using the ESR process has a cleanness of 0.010%; the exemplary embodiment steel prepared without the ESR process has a cleanness of 0.027%; the comparative steel A has a cleanness of 0.030%; and the comparative steel B has a cleanness of 0.027%. The exemplary embodiment steel prepared without the ESR process and the comparative steels A and B have the similar cleanness, while the exemplary embodiment steel prepared using the ESR process has a considerably higher cleanness than the exemplary embodiment steel prepared without the ESR process and the comparative steels A and B. This shows that the mold has a great minor-finished toughness.

While exemplary embodiments have been particularly shown and described above, it would be appreciated by those skilled in the art that various changes may be made therein without departing from the scope and spirit of the present inventive concept as defined by the following claims.

What is claimed is:

1. A mold steel comprising 0.15 to 0.40 wt. % of carbon (C), 0.15 to 0.50 wt. % of silicon (Si), 0.70 to 1.50 wt. % of manganese (Mn), 0.50 to 1.20 wt. % of nickel (Ni), 1.50 to 2.50 wt. % of chrome (Cr), 0.25 to 0.70 wt. % of molybdenum (Mo), 0.20 wt. % or less of vanadium (V), 0.010 wt. % or less of boron (B), and a trace of iron (Fe) and a plurality of impurities.

2. The mold steel as claimed in claim 1, further comprising 0.08 wt. % or less of zirconium (Zr) and 1.0 wt. % or less of copper (Cu).

3. The mold steel as claimed in claim 1, wherein the plurality of impurities comprise at least one of the phosphor (P), sulfur (S), aluminum (Al) and nitrogen (N).

4. The mold steel as claimed in claim 1, wherein the remainder of the mold steel comprises iron (Fe).

5. A method for manufacturing a mold steel, comprising:
preparing a steel ingot comprising carbon (C), 0.15 to 0.50 wt. % of silicon (Si), 0.70 to 1.50 wt. % of manganese (Mn), 0.50 to 1.20 wt. % of nickel (Ni), 1.50 to 2.50 wt. % of chrome (Cr), 0.25 to 0.70 wt. % of molybdenum (Mo), 0.20 wt. % or less of vanadium (V), 0.010 wt. % or less of boron (B), and a trace of iron (Fe) and other impurities for the remainder;
heating the prepared steel ingot;
performing a forging or rolling process, or a forging process and a rolling process in a sequence to prepare a mold material from the heated steel ingot;
preheating the prepared mold material; and
quality-heating the pre-heated mold material.

6. The method as claimed in claim 5, wherein the steel ingot further comprises 0.08 wt % of less of zirconium (Zr) and 1.0 wt. % of less of copper (Cu).

7. The method as claimed in claim 5 further comprising performing an electro-slag remelting (ESR) process prior to the heating the steel ingot.

8. The method as claimed in claim 5, wherein the heating the steel ingot comprises heating at a temperature of 850 to 1,300° C.

9. The method as claimed in claim 5, wherein the forging or rolling process or the forging process and the rolling process in the sequence are performed at a temperature of 850 to 1,300° C.

10. The method as claimed in claim 5, wherein the preheating the prepared mold material comprises heating at a temperature of 800 to 950° C. to perform austenitization and recrystallization and then air-cooling to perform a normalizing process.

11. The method as claimed in claim 5, wherein the preheating the prepared mold material comprises heating at a temperature of 800 to 950° C. to perform austenitization and recrystallization and then furnace-cooling to perform an annealing process.

12. The method as claimed in claim 5, wherein the quality-heating the pre-heated mold material comprises heating at 850 to 1,000° C. to perform transformation into austenite, quenching by any one cooling method selected from oil cooling, air cooling, or water cooling and then tempering at 400 to 650° C.

13. The method as claimed in claim 5, wherein the plurality of impurities comprise at least one of the phosphor (P), sulfur (S), aluminum (Al) and nitrogen (N).

14. The method as claimed in claim 5, wherein the remainder of the mold steel comprises iron (Fe).
